(19) United States
(12) Patent Application Publication
(10) Pub. No.: US 2013/0185090 A1
(43) Pub. Date: Jul. 18, 2013

(54) System for Preplanning Placement of Imaging Equipment and Medical Workers In an Operating Room

(71) Applicant: SIEMENS MEDICAL SOLUTIONS USA, INC., Malvem, PA (US)

(72) Inventors: Soroosh Kargar, Lake in the Hills, IL (US); Weng Lei, Mount Prospect, IL (US)

(73) Assignee: SIEMENS MEDICAL SOLUTIONS USA, INC., Malvern, PA (US)

(21) Appl. No.: 13/682,818

(22) Filed: Nov. 21, 2012

Related U.S. Application Data
(60) Provisional application No. 61/587,690, filed on Jan. 18, 2012.

(51) Int. Cl. G06Q 50/22

(52) U.S. Cl. CPC G06Q 50/22
USPC 705/2

(57) ABSTRACT

A medical procedure planning system uses a repository of information associating a type of interventional medical procedure with image acquisition angles used for acquiring images during a particular type of interventional medical procedure and with positions of workers having particular roles in a procedure in an operating room and with corresponding different stages of a medical procedure. A position processor, in response to receiving data identifying a medical procedure type, automatically uses the information and predetermined data identifying location and dimensions of an X-ray system C-arm and a patient support table in determining positions of a C-arm and workers at different stages of a medical procedure of the medical procedure type. A display processor provides a display image showing the determined positions of the C-arm and workers at different stages of the medical procedure.

This is a non-provisional application of provisional application Ser. No. 61/587,690 filed Jan. 18, 2012, by S. Kargar et al.

### FIELD OF THE INVENTION

This invention concerns a system for medical procedure equipment movement planning involving determining and presenting in an image, positions of an X-ray imaging system C-arm and workers at different stages of a medical procedure of a particular medical procedure type.

### BACKGROUND OF THE INVENTION

A Hybrid operating room (OR) is a complex working environment where a large team of medical staff (interventionists, surgeons, anesthesiologists, nurses and technicians) need to work seamlessly together. For instance, during a trans-catheter aortic-valve implantation (TAVI), there can be around 20 medical workers in an OR room along with different medical equipment and systems including an X-ray imaging system, for example. In known systems, placement of medical equipment and workers may obstruct robotic X-ray imaging system C-Arm access to a patient for image acquisition during surgery in a hybrid OR. As a result, an interventional procedure may need to be paused, and the equipment and workers moved to a different location within the OR. This is undesirable during surgery especially since a patient may already be undergoing a procedure. Rearrangement of the OR equipment and personnel takes time and may compromise patient safety. Furthermore, rearrangement of the equipment may need to be repeated if a subsequent rearrangement is not optimal (i.e. an imaging system C-Arm cannot reach required angles for a whole procedure). A system according to invention principles preplans equipment and worker placement in an OR by providing a planned layout of equipment and worker position for different stages of an interventional procedure before a procedure is initiated.

### SUMMARY OF THE INVENTION

A system preplans placement of equipment and medical staff to achieve optimal image acquisition angles of an imaging system for cardiac, vascular or neurological surgery procedures in a hybrid operating room, for example. A system for medical procedure equipment movement planning uses at least one repository of information, a position processor and a display processor. The at least one repository of information associates a type of interventional medical procedure with image acquisition angles used for acquiring images during a particular type of interventional medical procedure and with positions of workers having particular roles in a procedure in an operating room and with corresponding different stages of a medical procedure. The position processor, in response to receiving data identifying a medical procedure type, automatically uses the information and predetermined data identifying location and dimensions of an X-ray imaging system C-arm and a patient support table in determining positions of a C-arm and workers at different stages of a medical procedure of the medical procedure type. The display processor initiates generation of data representing a display image showing the determined positions of the C-arm and workers at different stages of the medical procedure.

### BRIEF DESCRIPTION OF THE DRAWING

FIG. 1 shows a system for medical procedure equipment movement planning, according to invention principles.

FIG. 2 shows a flowchart of a process employed the system for medical procedure equipment and worker movement planning, according to invention principles.

FIG. 3 shows a visual depiction of C-arm, worker and equipment position in a first stage (stage 1), according to invention principles.

FIG. 4 shows a visual depiction of C-arm, worker and equipment position in a second stage (stage 2), following movement from stage 1, for a Left heart study, according to invention principles.

FIG. 5 shows a further C-arm position stage, according to invention principles.

FIG. 6 shows visual identification of a collision zone of a C-arm position in stage 1, according to invention principles.

FIG. 7 shows visual identification of a collision zone of a C-arm position in stage 2, according to invention principles.

FIG. 8 shows visual identification of a collision free safe zone for workers and equipment, according to invention principles.

FIG. 9 shows a flowchart of a process employed by a system for medical procedure equipment movement planning, according to invention principles.

### DETAILED DESCRIPTION OF THE INVENTION

A system preplans placement of equipment and medical workers during different stages of a medical procedure in an OR to achieve optimal needed image acquisition angles of an imaging system for cardiac, vascular or neurological surgery procedures in a hybrid operating room, for example. The system advantageously informs responsible surgeons, radiologists and cardiologists of the different angles a robotic X-ray system C-arm needs to assume for different types of surgery (e.g. cardiac surgery) to acquire images in order to perform a particular procedure. The required angles are advantageously indicated in a lookup table or database for different types of procedure (e.g., a Transcatheter Aortic Valve Implantation (TAVI) procedure). The system provides a lookup table or database that identifies different procedures (e.g. a cardiac procedure) and maps the different types of procedure to the possible angles related to the procedures.

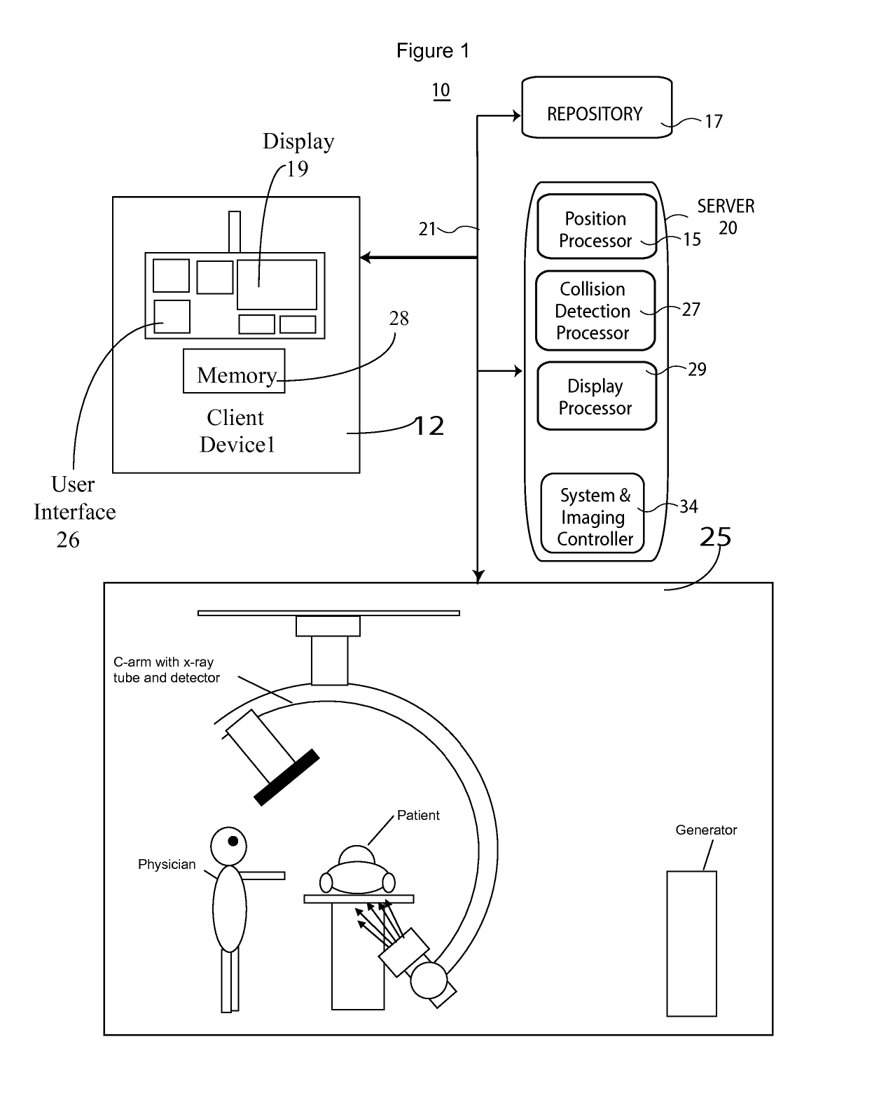

FIG. 1 shows system 10 for medical procedure equipment movement planning. System 10 includes one or more processing devices (e.g., workstations, computers or portable devices such as notebooks, Personal Digital Assistants, phones) 12 that individually include memory 28, a user interface 26 enabling user interaction with a Graphical User Interface (GUI) and display 19 supporting GUI and medical image presentation in response to predetermined user (e.g., physician) specific preferences. System 10 also includes at least one repository 17, server 20 and imaging device 25. Server 20 includes position processor 15, collision detection processor 27, display processor 29 and system and imaging control unit 34. System and imaging control unit 34 controls operation of one or more imaging devices 25 for performing image acquisition of patient anatomy in response to user command. Imaging device 25 may comprise a mono-plane or biplane X-ray imaging system, for example. The units of system 10 intercommunicate via network 21. At least one repository 17 stores X-ray and medical images and studies for patients in DICOM compatible (or other) data format. A medical image study individually includes multiple image series of a patient anatomical portion which in turn individually include multiple images.

At least one repository of information 17 associates a type of interventional medical procedure with image acquisition angles used for acquiring images during a particular type of interventional medical procedure and with positions of workers having particular roles in a procedure in an operating room and with corresponding different stages of a medical procedure. Position processor 15, in response to receiving data identifying a medical procedure type, automatically uses the information and predetermined data identifying location and dimensions of an X-ray imaging system C-arm and a patient support table in determining positions of a C-arm and workers at different stages of a medical procedure of the medical procedure type. Display processor 29 initiates generation of data representing a display image showing the determined positions of the C-arm and workers at different stages of the medical procedure.

System 10 in response to a data entry input identifying a procedure type, automatically selects equipment including an X-ray imaging system using a C-arm needed for a procedure and identifies number of workers and their roles needed for a procedure and automatically determines position of the equipment and workers for different stages of a procedure. The system automatically determines placement and simulates movement of equipment and workers during a procedure and provides a visual image (2D or 3D) layout in different orientations (e.g. overhead and side views) identifying placement of equipment and workers at the different stages of a procedure.

In response to equipment placement and movement simulation, the system presents data indicating the possible angles for that procedure to a physician. A physician modifies the angles if required and confirms the possible angles to be used. The simulation system performs C-Arm collision detection analysis based on the hybrid OR equipment and staff placement. If there is a possible C-Arm collision, the system informs a user of a C-Arm angle that cannot be achieved based on a current placement layout. The system prompts a user with a suggested different location for a highlighted object that is in a collision path or the system prompts a user with a different imaging angle that prevents the collision. The system 10 user interface enables a user to accept a suggestion or select a different location of the highlighted object or a different imaging angle. Collision detection processor 27 processes the user determined device and worker placement data to ensure equipment placement in the OR is optimal.

Collision detection processor 27 checks for obstruction in a path of C-arm movement to a particular angle based on a current location of the C-Arm. Processor 27 detects an obstruction in a C-arm path of movement and highlights the object in collision with the C-arm in a 2D or 3D image presentation and identifies a specific image acquisition angle that cannot be achieved as it results in a collision. Processor 27 repeats the obstruction checking and detection steps until the C-Arm angles used for imaging of a particular procedure type have been checked and verified as valid.

System 10 advantageously positions medical equipment and workers in an optimal location for surgery in a hybrid OR. The system preplans placement of equipment and medical workers to achieve optimal needed image acquisition angles of imaging system 25 for cardiac, vascular or neurological surgery procedures in a hybrid operating room. The system employs a lookup table associating different procedure types with different angular positions of a C arm and with different numbers of workers having particular roles and different positions of workers in the OR. In one embodiment, the lookup table is populated by a user in a configuration step, in consultation with surgeons and for particular procedures performed in the OR. Collision detection processor 27 calculates a collision zone and highlights objects (equipment/staff) that are within the collision zone in a visual display image, for example.

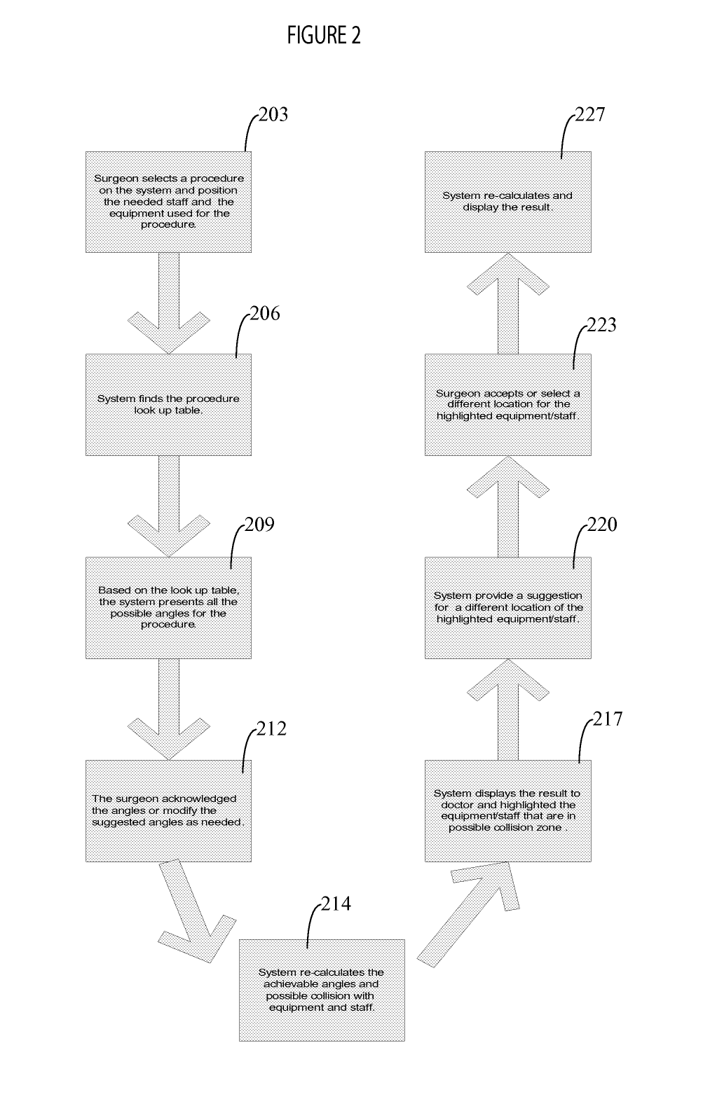

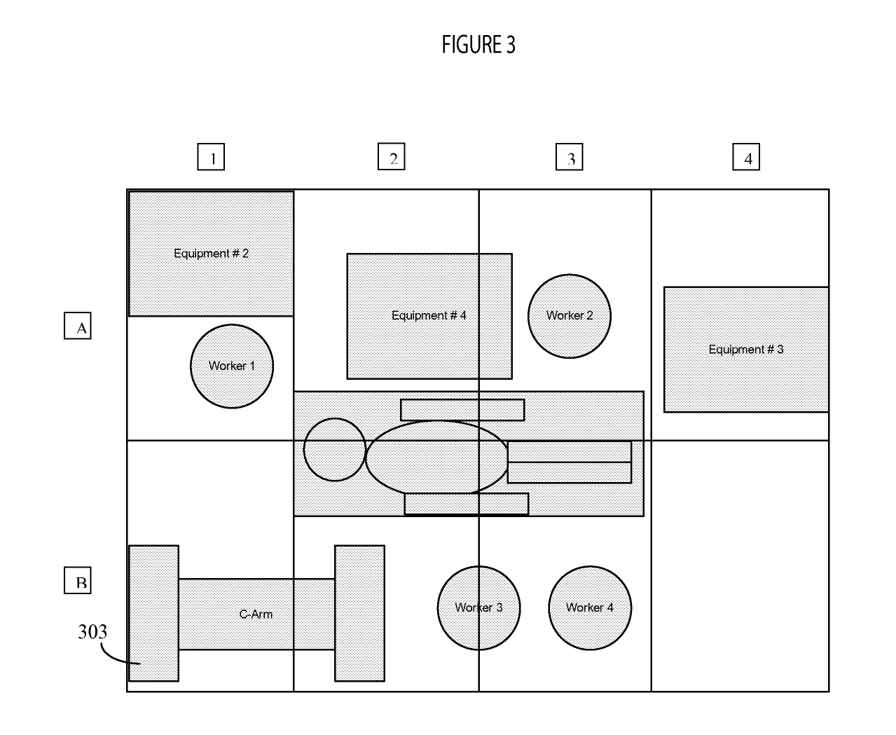

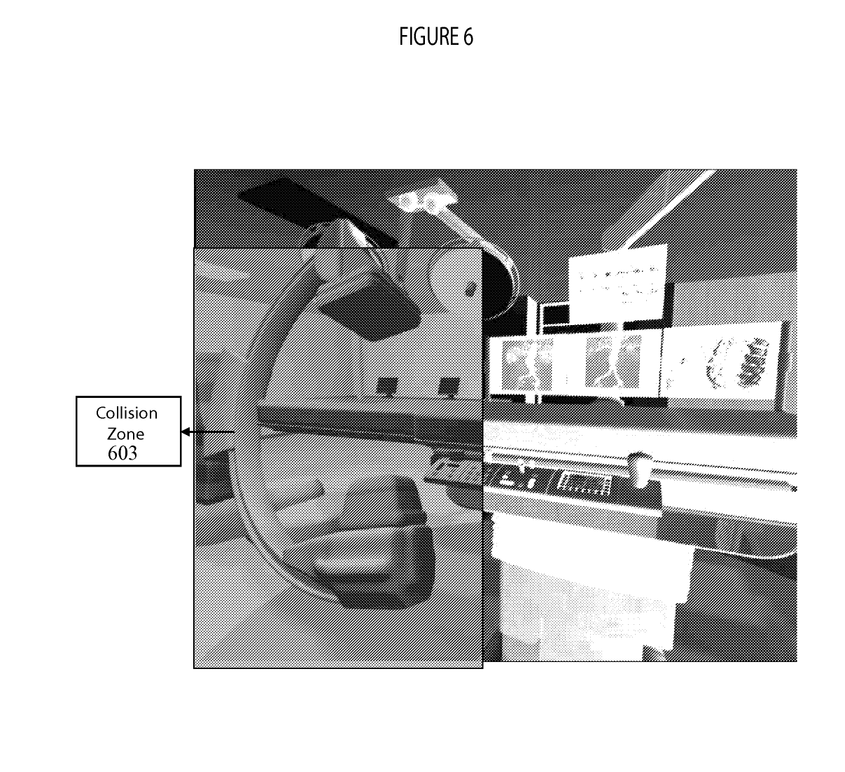

FIG. 2 shows a flowchart of a process employed by system 10 for medical procedure equipment and worker movement planning. In step 203, position processor 15 of system 10 receives physician entered data identifying a medical imaging procedure to be performed and initial candidate positions of workers and equipment. FIG. 3 shows a visual depiction of C-arm (equipment #1) 303, worker and equipment position in a first stage (stage 1). C-arm 303 is shown in a park position in stage 1. Position processor 15 maintains a stage 1 position table showing worker and equipment position in a visual depiction corresponding to an imaging room with table cells corresponding to room sections. The stage 1 table is presented on display 19 and comprises, for example,

| | 1 | 2 | 3 | 4 |
|---|---|---|---|---|
| A | E2, W1 | E4 | E4, W2 | E3 |
| B | | W3 | W3, W4 | |

Where E2, E3, E4 comprise equipment items and W1, W2, W3, W4 comprise workers. Grid cells of the table and FIG. 3 placement diagram use corresponding row identifiers (A, B) and column identifiers (1, 2, 3, 4). FIG. 6 shows photographic visual identification of collision zone 603 of C-arm 303 position in stage 1. The photographic visual identification is presented on display 19 together with the visual depiction of FIG. 3.

Processor 15 in step 209 determines candidate C-arm imaging angles associated with the imaging procedure selected in step 203 using a lookup table in repository 17 accessed in step 206. The physician in step 212 acknowledges the candidate C-arm imaging angles or modifies the angles, using user interface 26. In step 214 processor 15 determines whether the C-arm imaging angles selected in step 212 result in a potential collision with a worker or equipment. Position processor 15 provides a stage 1 to stage 2 transition collision table showing collision zones where a worker and equipment may collide with a C-arm. The collision table provides a visual depiction corresponding to an imaging room with table cells corresponding to room sections and identifying safe zones and collision zones where a worker or equipment may collide with a C-arm. A collision table for a Left heart study where a C arm moves from a parking position to a stage 2 comprises, for example,

| | 1 | 2 | 3 | 4 |
|---|---|---|---|---|
| A | safe | collision | collision | safe |
| B | safe | collision | collision | safe |

In step 217, display 19 presents data identifying the potential collision and highlighting equipment and workers that are involved in a potential collision in a visual depiction of an imaging room. Position processor 15 in step 220 uses the position table and collision table in identifying an alternative candidate position of equipment and workers that avoids the potential collision. Display 19 presents the alternative candidate position of equipment and workers in the visual depiction of the imaging room. The physician in step 223 enters data accepting the alternative candidate position of equipment and workers or selecting a different candidate position of equipment and workers. Processor 15 in step 227 uses the position table and collision table in identifying whether the C-arm imaging angles result in a potential collision with the worker and equipment positions selected in step 223 and alerts a user if there is a collision via display 19

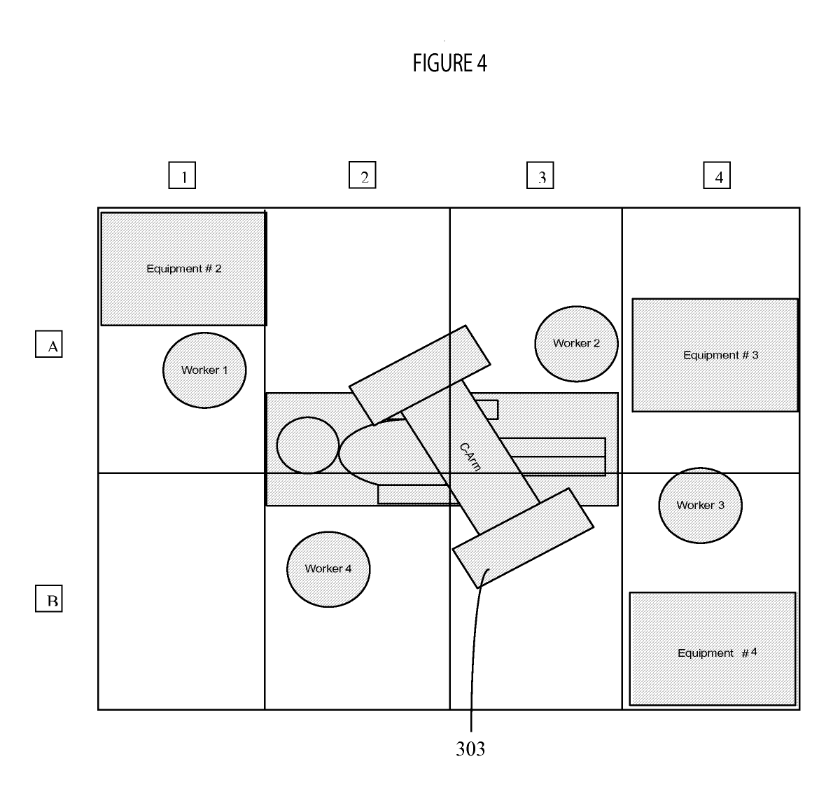

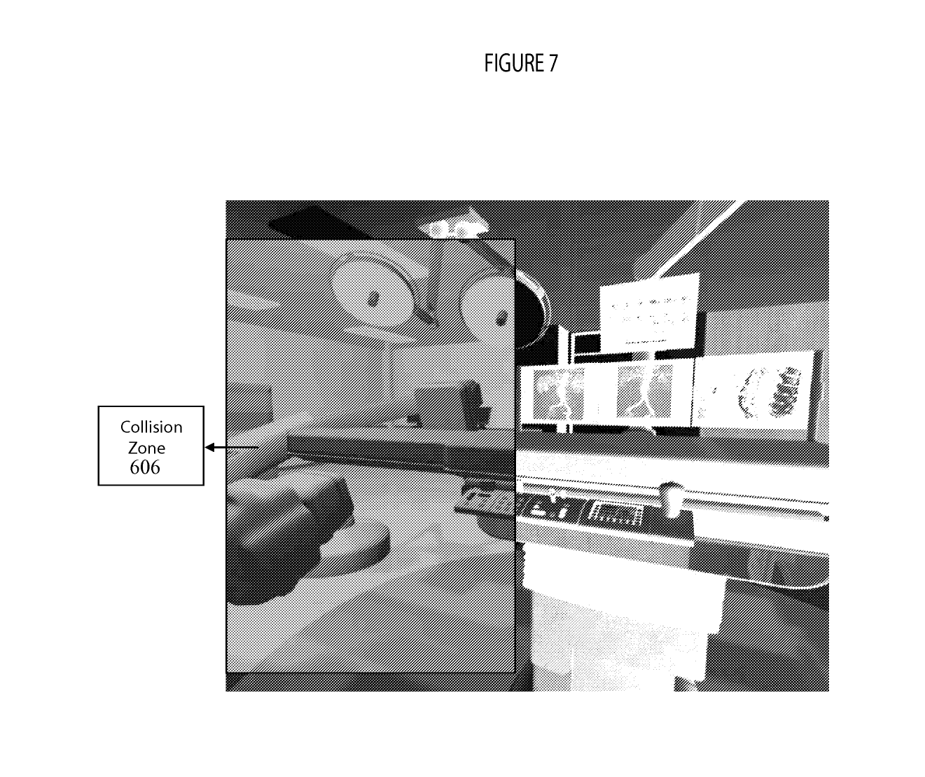

FIG. 4 shows a visual depiction of C-arm 303, worker and equipment positions in a second stage (stage 2), following movement from stage 1, for a Left heart study. C-arm 303 is shown in an imaging position in stage 2. FIG. 7 shows photographic visual identification of collision zone 606 of the C-arm 303 position in stage 2. Position processor 15 provides a stage 2 position table presented on display 19 comprising,

| | 1 | 2 | 3 | 4 |
|---|---|---|---|---|
| A | E2, W1 | | W2 | E3, W3 |
| B | | W4 | | W3, E4 |

Position processor 15 provides a stage 2 collision table showing collision zones where a worker and equipment may collide with a C-arm. The collision table for a Left heart study in stage 2 comprises,

| | 1 | 2 | 3 | 4 |
|---|---|---|---|---|
| A | safe | collision | safe | safe |
| B | safe | safe | collision | safe |

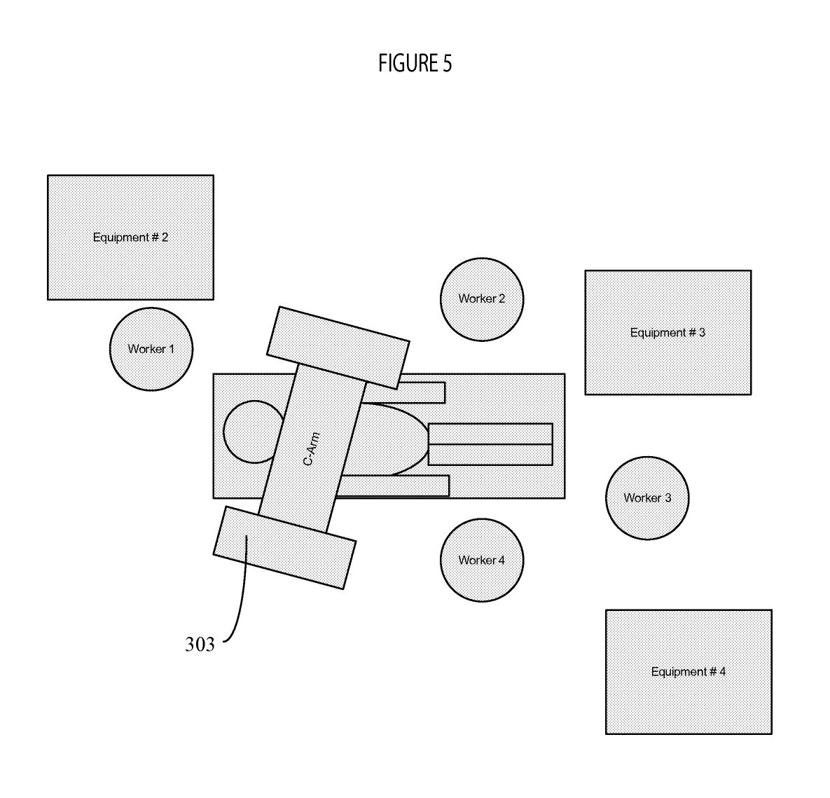

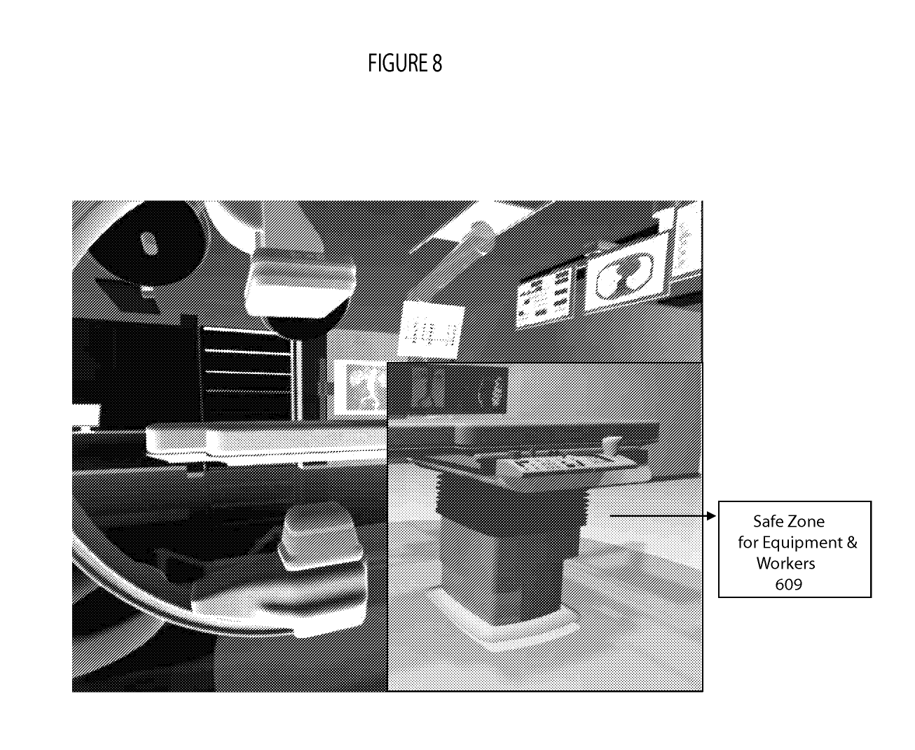

The process iteratively repeats from step 217 until a valid configuration is determined or the system terminates selection after a number of iterations exceeding a predetermined limit (e.g. 3 iterations). FIG. 5 shows a further C-arm position stage 3 used for imaging in a Left heart study. FIG. 8 shows photographic visual identification of collision free safe zone 609 for workers and equipment derived based on FIGS. 3 and 4.

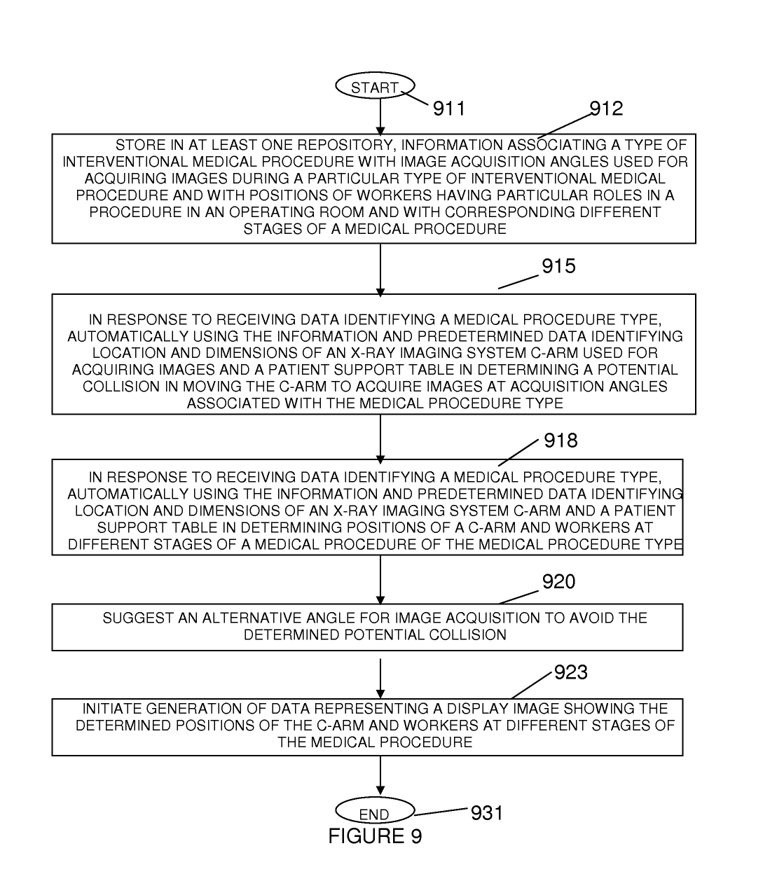

FIG. 9 shows a flowchart of a process employed by system 10 (FIG. 1) for medical procedure equipment movement planning. In step 912 following the start at step 911, position processor 15 stores in at least one repository, information associating a type of interventional medical procedure with image acquisition angles used for acquiring images during a particular type of interventional medical procedure and with positions of workers having particular roles in a procedure in an operating room and with corresponding different stages of a medical procedure. In step 915, processor 15, in response to receiving data identifying a medical procedure type, automatically uses the information and predetermined data identifying location and dimensions of an X-ray imaging system C-arm and a patient support table in determining positions of a C-arm and workers at different stages of a medical procedure of the medical procedure type. Collision detection processor 27 in step 918 in response to receiving data identifying a medical procedure type, automatically uses the information and predetermined data identifying location and dimensions of an X-ray imaging system C-arm used for acquiring images and a patient support table in determining a potential collision in moving the C-arm to acquire images at acquisition angles associated with the medical procedure type.

In step 920, collision detection processor 27 uses a position table and collision table in identifying and suggesting an alternative angle for image acquisition to avoid the determined potential collision. Display processor 29 in step 923 initiates generation of data representing a display image alerting a user to a determined potential collision and showing the determined positions of the X-ray imaging system C-arm and workers at different stages of the medical procedure and patient support table and indicating a collision position. In one embodiment the display image shows the X-ray imaging system C-arm and patient support table in an overhead view of the X-ray imaging system C-arm and patient support table and indicates the collision position. In another embodiment, the display image includes a photographic image showing an X-ray imaging system C-arm and patient support table and indicates at least one of, (a) a safe zone and (b) a collision zone in the display image showing the X-ray imaging system C-arm and patient support table. The process of FIG. 9 terminates at step 931.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. A histogram of an image is a graph that plots the number of pixels (on the y-axis herein) in the image having a specific intensity value (on the x-axis herein) against the range of available intensity values. The resultant curve is useful in evaluating image content and can be used to process the image for improved display (e.g. enhancing contrast).

The system and processes of FIGS. 1-9 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system preplans placement of equipment and medical workers during different stages of a medical procedure in an OR to achieve optimal needed image acquisition angles of an imaging system for cardiac, vascular or neurological surgery procedures using a database that identifies different procedures and maps the different types of procedure to the possible angles related to the procedures. Further, the processes and applications may, in alternative embodiments, be located on one or more (e.g., distributed) processing devices on a network linking the units FIG. 1. Any of the functions and steps provided in FIGS. 1-9 may be implemented in hardware, software or a combination of both. No claim element herein is to be construed under the provisions of 35 U.S.C. 112, sixth paragraph, unless the element is expressly recited using the phrase “means for.”

What is claimed is:

1. A system for medical procedure equipment movement planning, comprising:
at least one repository of information associating a type of interventional medical procedure with image acquisition angles used for acquiring images during a particular type of interventional medical procedure and with positions of workers having particular roles in a procedure in an operating room and with corresponding different stages of a medical procedure;
a position processor for, in response to receiving data identifying a medical procedure type, automatically using the information and predetermined data identifying location and dimensions of an X-ray imaging system C-arm and a patient support table in determining positions of a C-arm and workers at different stages of a medical procedure of said medical procedure type; and
a display processor for initiating generation of data representing a display image showing the determined positions of said C-arm and workers at different stages of said medical procedure.

2. A system according to claim 1, wherein
said display processor initiates generation of data representing a display image showing an X-ray imaging system C-arm and patient support table and indicating a collision position.

3. A system according to claim 2, wherein
said display image shows an overhead view of said X-ray imaging system C-arm and patient support table and indicating said collision position.

4. A system according to claim 1, including
a collision detection processor for, in response to receiving data identifying a medical procedure type, automatically using the information and predetermined data identifying location and dimensions of an X-ray imaging system C-arm used for acquiring images and a patient support table in determining a potential collision in moving the C-arm to acquire images at acquisition angles associated with said medical procedure type.

5. A system according to claim 4, including
said collision detection processor suggests an alternative angle for image acquisition to avoid the determined potential collision.

6. A system for medical procedure equipment movement planning, comprising:
at least one repository of information associating a type of interventional medical procedure with image acquisition angles used for acquiring images during a particular type of interventional medical procedure;
a collision detection processor for, in response to receiving data identifying a medical procedure type, automatically using the information and predetermined data identifying location and dimensions of an X-ray imaging system C-arm used for acquiring images and patient support table in determining a potential collision in moving the C-arm to acquire images at acquisition angles associated with said medical procedure type; and
a display processor for initiating generation of data representing a display image alerting a user to a determined potential collision.

7. A system according to claim 6, wherein
said collision detection processor suggests an alternative angle for image acquisition to avoid said determined potential collision.

8. A system according to claim 1, including
said display processor initiates generation of data representing a display image showing an X-ray imaging system C-arm and patient support table and indicating a collision position.

9. A system according to claim 6, wherein
said at least one repository of information associates a type of interventional medical procedure with image acquisition angles used for acquiring images during a particular type of interventional medical procedure and with positions of workers having particular roles in a procedure in an operating room and with corresponding different stages of a medical procedure.

10. A system according to claim 9, including
a position processor for, in response to receiving data identifying a medical procedure type, automatically using the information and predetermined data identifying location and dimensions of an X-ray imaging system C-arm and a patient support table in determining positions of a C-arm and workers at different stages of a medical procedure of said medical procedure type.

11. A system according to claim 10, wherein
said display processor initiates generation of data representing a display image showing the determined positions of said C-arm and workers at different stages of said medical procedure.

12. A method for medical procedure equipment movement planning, comprising the activities of:
storing in at least one repository, information associating a type of interventional medical procedure with image acquisition angles used for acquiring images during a particular type of interventional medical procedure and with positions of workers having particular roles in a procedure in an operating room and with corresponding different stages of a medical procedure;
in response to receiving data identifying a medical procedure type, automatically using the information and predetermined data identifying location and dimensions of an X-ray imaging system C-arm and a patient support table in determining positions of a C-arm and workers at different stages of a medical procedure of said medical procedure type; and
initiating generation of data representing a display image showing the determined positions of said C-arm and workers at different stages of said medical procedure.

13. A method according to claim 12, including the activity of
initiating generation of data representing a display image showing an X-ray imaging system C-arm and patient support table and indicating a collision position.

14. A method according to claim 13, including the activity of
including a photographic image showing an X-ray imaging system C-arm and patient support table and indicating at least one of, (a) a safe zone and (b) a collision zone in said display image showing said X-ray imaging system C-arm and patient support table.

15. A method according to claim 13, wherein
said display image showing said X-ray imaging system C-arm and patient support table shows an overhead view of said X-ray imaging system C-arm and patient support table and indicating said collision position.

16. A method according to claim 12, including the activity of
in response to receiving data identifying a medical procedure type, automatically using the information and predetermined data identifying location and dimensions of an X-ray imaging system C-arm used for acquiring images and a patient support table in determining a potential collision in moving the C-arm to acquire images at acquisition angles associated with said medical procedure type.

17. A method according to claim 16, including the activity of
suggesting an alternative angle for image acquisition to avoid the determined potential collision.
